(19) United States
(12) Patent Application Publication
(10) Pub. No.: US 2006/0132087 A1
(43) Pub. Date: Jun. 22, 2006

(54) Electronic device with function of protection against abnormal charging

(75) Inventors: Chih-Chang Chen, Tainan County (TW); Wei-Peng Kao, Kaohsiung City (TW); Tsung-Ju Tsai, Yunlin County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/300,454

(22) Filed: Dec. 15, 2005

(30) Foreign Application Priority Data
Dec. 17, 2004 (TW) 093139283

(51) Int. Cl. H02J 7/00

(52) U.S. Cl. 320/107

(57) ABSTRACT

The present invention relates to an electronic device, comprising: a battery; a breaker, coupled to the battery, being activated to brake a circuit while a current flowing therethrough exceeds a default current value of the breaker; and a switcher, having an end coupled to the breaker and another end being grounded, being activated to a short circuit state for directing the current to the ground and enabling the current to be larger than the default current value while the switcher detects an abnormal status.

### FIELD OF THE INVENTION

The present invention relates to an electronic device, and more particularly, to an electronic device with function of protection against abnormal charging.

### BACKGROUND OF THE INVENTION

With rapid advance of technology, secondary batteries are extensively being employed as the power supply for various portable electronic devices and apparatuses, such as notebook-sized personal computers, PDAs, cellular phones, Mini Disc (MD) drives, and video cameras. As a secondary battery, often nickel-hydrogen batteries or nickel-cadmium batteries are used, where such use is employed typically since they can enhance the portability of many abovementioned electronic devices and thus bring convenience to our daily life, which is especially true in cellular phones.

However, if a secondary battery such as a nickel-hydrogen battery, a nickel-cadmium battery, a lithium ion battery, or a lithium-polymer battery, is in an over-charging state or an over-discharging state, problems such as lowered performance, damaged electrodes, or even explosion may occur. When an incidence of battery explosion occurs, it is usually because of incompatible, faulty or counterfeit batteries or chargers, and among those, the use of counterfeit batteries is the most common cause. However, it is difficult to encourage consumer to use a brand-name battery since the price of the generic batteries is much lower than that of the brand-name batteries. By virtue of this, burns to the face, neck, legs and hips, and even blindness are among the injury reports due to the degradation of generic batteries used in portable electronic devices.

Over the past few years, Federal safety officials have received 77 reports of cell phones exploding or catching fire. For solving the potential hazard of battery explosion, other than recommending the use of brand-name batteries, manufacturers of portable electronic devices have come up with many solutions for ensuring the safety of consumers while suing the portable electronic devices, especially a cellular phone.

Currently, it is common to use software for controlling the overcharging of batteries. Nevertheless, the software protection mechanism is prone to be erroneously activated, and furthermore, it usually can not be activated in time, such that it is often for a portable device to be damaged while the software protection mechanism is still inactive. Another means commonly adopted for solving the overcharging of batteries is by adding a control chip in the portable electronic device for controlling charging and discharging of the same. However, the additional chip will increase the manufacturing cost of the electronic device and this is unfavorable for the highly competitive market. Therefore, it is in great demand to have a reliable and cost effective device capable of ensuring consumer safety.

### SUMMARY OF THE INVENTION

It is the primary object of the invention to provide an electronic device capable of ensuring consumer safety.

To achieve the above object, the present invention provides an electronic device, comprising:
a battery;
a breaker, coupled to the battery, being activated to brake a circuit while a current flowing therethrough exceeds a default current value of the breaker; and
a switcher, having an end coupled to the breaker and another end being grounded, being activated to a short circuit state for directing the current to the ground and enabling the current to be larger than the default current value while the switcher detects an abnormal status.

### BRIEF DESCRIPTION OF THE DRAWINGS

FIG. 1 is an illustration showing an electronic device according to the first embodiment of the invention.

FIG. 2 is an illustration showing an electronic device according to the second embodiment of the invention.

FIG. 3 is an illustration showing an electronic device according to the third embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

The electronic device can be characterized in that the electric circuit of the electronic device is being monitored constantly for detecting any abnormal status and is being shot down while detecting an abnormal status exceeding a predetermined specification so as to protect the electronic device from being damaged.

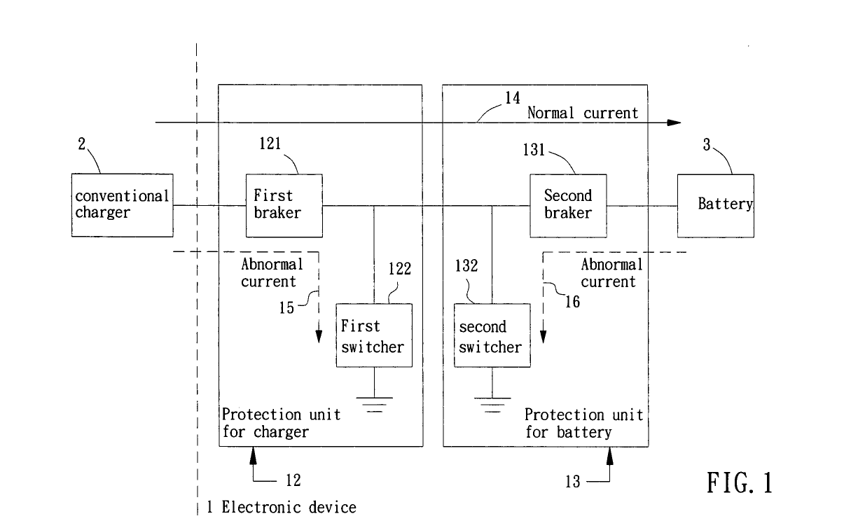

Please refer to FIG. 1, which is an illustration showing an electronic device according to the first embodiment of the invention. The electronic device 1 seen in FIG. 1 can be any electronic device, such as a cellular phone, a PDA, a digital camera, a notebook PC, and so on, which has secondary battery pack arranged therein and capable of being charged by a conventional charger 2.

As seen in FIG. 1, a protection unit for charger 12 is placed in the electronic device 1 and is connected directly to a conventional charger 2 for protecting the electronic device 1, the protection unit 12 comprising: a first breaker 121, capable of being activated to brake a circuit while a first current flowing therethrough exceeds a specific first current value of the first breaker 121; and a first switcher 122, having an end coupled to the first breaker 121 and another end grounded, being activated to a short circuit state for directing the first current to the ground and enabling the first current to be larger than the specific first current value for activating the first breaker 121 while the first switcher 122 detects a first abnormal status; wherein the first abnormal status is defined as detecting the voltage or temperature of the switcher 122 being higher than a predetermined value.

Similarly, a protection unit for battery 13 is placed in the electronic device 1 and is connected directly to a battery 3 for protecting the electronic device 1, the protection unit 13 comprising: a second breaker 131 coupled to the battery 3, capable of being activated to brake a circuit while a second current flowing therethrough exceeds a specific second current value of the second breaker 131; and a second switcher 132, having an end coupled to the second breaker 131 and another end grounded, being activated to a short circuit state for directing the second current to the ground and enabling the second current to be larger than the specific second current value for activating the second breaker 131 while the first switcher 132 detects a second abnormal status; wherein the second abnormal status is defined as detecting the voltage or temperature of the switcher 132 being higher than a predetermined value.

As the electronic device 1 is being charged normally, a current for charging the device 1 will flow following the normal current path according to the solid arrow 14, that is, flowing through the first breaker 121, the second breaker 131 and finally to the battery 3 for charging the battery 3. However, when an abnormal occurs that enables the charger 2 to discharge abnormally and therefore causes the current to be raised to an abnormal level, the state of the first switcher 122, which is originally in the cut-off state, is switched to the short circuit state as soon as the first switcher 122 detects the abnormal current. As the first switcher 122 is in the short circuit state, most of the current will be redirected to the ground through the first switcher 122 following the abnormal current path according to the dotted arrow 15 since the resistance of the abnormal current path 15 is smaller than that of the normal current path 14, such that the electronic device 1 can be protected from being damaged by the abnormal status. Furthermore, under the condition that a smaller resistance will induce a larger current, if the current following into the electronic device 1 is being raised to a level higher than a predetermined first current level, the first breaker 121 will be activated to the cut-off state so as to prevent the electronic device 1 to be damaged by the continuous abnormal current.

On the other hand, if the battery 3 is discharging abnormally during a charging process that cause an abnormal current to be generated, the state of the second switcher 132, which is originally in the cut-off state, is switched to the short circuit state as soon as the second switcher 132 detects the abnormal current, such that the abnormal current will be redirected to the ground through the second switcher 132 following the abnormal current path according to the dotted arrow 16. However, if the abnormal current is increasing continuously, the second breaker 131 will be activated to the cut-off state so as to prevent the electronic device 1 to be damaged by the continuous abnormal current.

In a preferred embodiment of the invention, both the first switcher 122 and the second switcher 132 can be respectively a circuit composed of a zener diode, which will break down at a specific voltage by making use of the zener effect. For example, if the first switcher 122 is a zener diode which break down at 6.8V, the state of the first switcher 122 is switched from the cut-off, state to the conductive state as soon as the voltage of the first switcher 122 reaches 6.8V, and similarly, if the second switcher 132 is another zener diode which break down at 4.4V, the state of the second switcher 132 is switched from the cut-off state to the short circuit state as soon as the voltage of the second switcher 132 reaches 4.4V.

In a preferred embodiment of the invention, both the first breaker 121 and the second breaker 131 can be respectively a fuse with a predetermined first current value of 750 mA and a fuse with a predetermined second current value of 400 mA that can be melt and cut-off as soon as the current flowing therethrough reaches the corresponding current value.

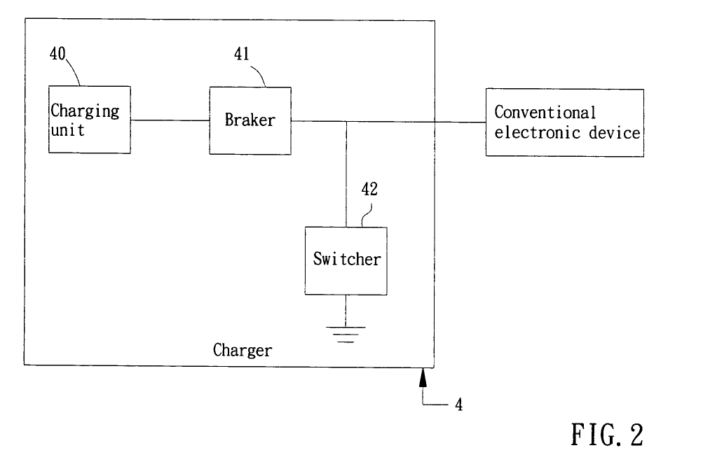

Please refer to FIG. 2, which is an illustration showing an electronic device according to the second embodiment of the invention. As seen in FIG. 2, the device of the invention is a charger 4, comprising: a charging unit 40, for providing power to charge an electronic device; a breaker 41, coupled between the electronic device and the charging unit 40, being activated to brake a circuit while a current flowing therethrough exceeds a default current value of the breaker 41, e.g. 750 mA; and a switcher 42, having an end coupled to the breaker 41 and another end grounded, being activated to a short circuit state for directing the current to the ground, enabling the current to be larger than the default current value and activating the breaker 41 to the cut-off state while the switcher 42 detects an abnormal status, such as the voltage of the switcher 42 is larger than 6.8V. Additionally, in a preferred embodiment of the invention, the breaker 41 can be a fuse, and the switcher 42 can be a circuit composed of a zener diode.

The foregoing charger 4 can be used for charging any conventional electronic device and is capable of directing the charging current to the ground during an abnormal status so as to protect the electronic device from being damaged, moreover, the breaker 41 can cut off the charging circuit while the abnormal status continues and the charging current is larger than a default value so as to protect both the electronic device and the charger 4 from being damaged and generating accidents such as fire hazard, explosion, electric leakage, etc.

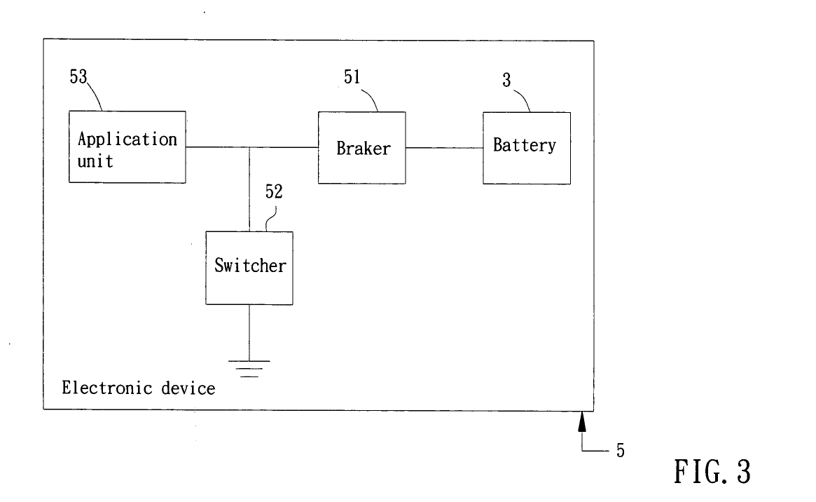

Please refer to FIG. 3, which is an illustration showing an electronic device according to the third embodiment of the invention. The electronic device 5 of the present invention is a device using a battery pack arranged therein for providing power to the same. As the battery is discharging while the electronic device 5 is operating and usually being placed at a location pretty close to the user's body, it is important to have protection mechanism built therein for proventing the injury caused by battery explosion.

The electronic device 5 of the invention comprises: a battery 3, for providing power to the electronic device 5; a breaker 51, coupled between the battery 3 and the an application unit 53, being activated to brake a circuit while a current flowing therethrough exceeds a default current value of the breaker 51, e.g. 400 mA; and a switcher 52, having an end coupled to the breaker 51 and another end grounded, being activated to a short circuit state for directing the current to the ground, enabling the current to be larger than the default current value and activating the breaker 51 to the cut-off state while the switcher 52 detects an abnormal status, such as the voltage of the switcher 52 is larger than 4.4V. Additionally, in a preferred embodiment of the invention, the breaker 51 can be a fuse, and the switcher 52 can be a circuit composed of a zener diode.

While the battery is discharging abnormally inducing the raise of current, the breaker 51 is activated to the cut-off state for protecting both the user and the electronic device 5. Further, the electronic device 5 is required to be maintained and inspected by the service center of the manufacturer of the device so as to revive the breaker 51, e.g. replacing the melt fuse with a new fuse. By virtue of this, not only the user of the electronic device 5 is free from the danger of battery explosion, but also the electronic device 5 itself is being protected and can be operational without major repair or requiring to be replaced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An electronic device, comprising:
a battery;
a breaker coupled to the battery, being activated to brake a circuit while a current flowing therethrough exceeds a default current value of the breaker; and
a switcher, having an end coupled to the breaker and another end grounded, being activated to a short circuit state for directing the current to the ground and enabling the current to be larger than the default current value while the switcher detects an abnormal status.

2. The electronic device as recited in claim 1, wherein the breaker is a fuse.

3. The electronic device as recited in claim 1, wherein the switcher is a zener diode.

4. The electronic device as recited in claim 1, wherein the abnormal status is defined as detecting the voltage of the switcher being higher than a predetermined value.

5. A charger, comprising:
a charging unit;
a breaker, coupled to the charging unit, being activated to brake a circuit while a current flowing therethrough exceeds a default current value of the breaker; and
a switcher, having an end coupled to the breaker and another end grounded, being activated to a short circuit state for directing the current to the ground and enabling the current to be larger than the default current value while the switcher detects an abnormal status.

6. The charger as recited in claim 5, wherein the breaker is a fuse.

7. The charger as recited in claim 5, wherein the switcher is a zener diode.

8. The charger as recited in claim 5, wherein the abnormal status is defined as detecting the voltage of the switcher being higher than a predetermined value.

9. An electronic device, being charged by a charger, comprising:
a battery;
a protection unit for the charger, further comprising:
a first breaker, coupled to the charger, being activated to brake a circuit while a first current flowing therethrough exceeds a specific first current value of the first breaker; and
a first switcher, having an end coupled to the first breaker and another end grounded, being activated to a short circuit state for directing the first current to the ground and enabling the first current to be larger than the specific first current value while the first switcher detects a first abnormal status.
a protection unit for the battery, further comprising
a second breaker, coupled to the battery, being activated to brake a circuit while a second current flowing therethrough exceeds a specific second current value of the second breaker; and
a second switcher, having an end coupled to the second breaker and another end grounded, being activated to a short circuit state for directing the second current to the ground and enabling the second current to be larger than the specific second current value while the second switcher detects a second abnormal status.

10. The electronic device as recited in claim 9, wherein the first breaker is a fuse.

11. The electronic device as recited in claim 9, wherein the second breaker is a fuse.

12. The electronic device as recited in claim 9, wherein the first switcher is a zener diode.

13. The electronic device as recited in claim 9, wherein the second switcher is a zener diode.

14. The electronic device as recited in claim 9, wherein the first abnormal status is defined as detecting the voltage of the first switcher being higher than a predetermined value.

15. The electronic device as recited in claim 9, wherein the second abnormal status is defined as detecting the voltage of the second switcher being higher than a predetermined value.
